(19) United States
(12) Patent Application Publication
(10) Pub. No.: US 2001/0032157 A1
(43) Pub. Date: Oct. 18, 2001

(54) Method and system of raising money

(76) Inventors: Ross Alan Dannenberg, Alexandria, VA (US); Michael Allen Briggs, Arlington, VA (US)

Correspondence Address: ROSS DANNENBERG, UNIT 502, 1200 BRADDOCK PLACE, ALEXANDRIA, VA, 22314, US

(21) Appl. No.: 09/738,931

(22) Filed: Dec. 16, 2000

Related U.S. Application Data
(60) Provisional application No. 60/173,490, filed on Dec. 29, 1999.

(51) Int. Cl. G06F 17/60

(52) U.S. Cl. 705/36; 705/14

(57) ABSTRACT

A method and system for raising money for a new business idea, wherein the system forms and maintains investor groups, each of the individual investors in the investor group having contributed less money than a minimum amount required per investor by an entrepreneur, but whose total amount of money contributed meets or exceeds that minimum amount required by the entrepreneur, with an appointed agent to act as a representative of the investor group to the entrepreneur. The system is implemented via a client-server based system on a global computer network such as the Internet.

The present application claims the benefit of U.S. provisional application 60/173,490.

### FIELD

The present invention relates to the field of fiance. More specifically, the present invention is a method and system of raising capital for investments over the Internet.

### BACKGROUND

Venture capital, generally, refers to the business of financing new business undertakings, usually high risk, in the hopes of reaping big rewards if the new business is successful. In a typical scenario, an inventor, entrepreneur, businessman, or other individual or group with a new idea will ask a venture capitalist to give them money to start a business built around the new idea. In this application, anyone seeking venture capital will be included under the term “entrepreneur.” Venture capitalists, or VC's, can be individuals, partnerships, corporations, or any other group with excess capital that is willing to invest in a hi-risk business idea. The financial return for the venture capitalist may be large, or the investment could be a total loss.

When an entrepreneur seeks money from VC, the amount sought after is often $100,000 or higher. Sometimes the amount sought after is in the millions of dollars, reinforcing the adage “it takes money to make money.” In such a case, the entrepreneur seeking money will often put a minimum limit on the amount accepted from a single investor. For example, if an entrepreneur is seeking $1,000,000 from VC's, the entrepreneur might require that each VC invest no less than $50,000.

This is no problem for venture capitalists. VC's often get into the business of venture capital simply because they can afford to. That is, a VC has money to invest and seeks a higher return than typical investments, such as certificates of deposit or mutual funds, normally offer. Thus, the minimum investment required by an entrepreneur poses no problem, as the VC can easily afford it. There is a problem, however, in that the amount required for the minimum investment often limits the entrepreneur. That is, the entrepreneur is limited to soliciting funds only from those individuals, or VC's, who have at least as much as the minimum investment amount.

An entrepreneur could accept any minute amount of money, such as $500 or $1,000, from any investor wiling to invest in them. However, this creates an administrative nightmare. If an investor seeks one million dollars, and receives it in denominations of one thousand dollars, the entrepreneur must administer the profits/losses with respect to 1,000 investors. This alone is a daunting task. In addition, often the investment amounts by each VC are not equal. In such a case, the entrepreneur must administer the profits/losses to investors, each having invested a different amount of money. If the two problems are combined, an entrepreneur finds himself administering the profits/losses to 1,000 investors, each having invested a different amount of money. There is a problem because the entrepreneur should be spending his time and money building the new business, not on administering the finances. Even if an entrepreneur could successfully manage 1,000 plus investors, many of whom have invested different amounts of money, it would be difficult for the entrepreneur to find 1,000 people willing to invest in their idea.

It would be an advancement in the art if an entrepreneur could successfully find many investors willing to invest a minimum sum, such as $500 or $1,000, in the entrepreneur's new idea, without the entrepreneur being required to handle the multiplicity of miniscule administrative tasks associated with each investor.

It would be another advancement in the art if the entrepreneur could easily manage, or not have to manage, the group of investors who have invested in the entrepreneur's new business.

### SUMMARY

The present invention relates to the field of finance. Specifically, an embodiment of the present invention is a method and system of raising financial capital for a new business venture, or entrepreneur, over a globally connected computer network such as the Internet or its equivalent.

The invention forms and maintains investor groups via a client-server computer system. The present invention forms a pool of investors, each of whom have contributed less money than the minimum amount required, but whose total amount of money meets or exceeds that minimum amount required by the new business or entrepreneur. The inventive method and system are performed and maintained via a globally connected computer network, such as the Internet.

### DESCRIPTION OF THE DRAWINGS

FIG. 1 depicts the method of raising capital through the current system; and

FIG. 2 depicts the relationship of the Agent, the Users, and the Entrepreneur.

### DETAILED DESCRIPTION OF THE INVENTION

The present invention relates to the field of finance. Specifically, the invention is a method and system of raising money for investing in businesses, movies, or other revenue generating ideas. The invention will now be described with reference to the figures.

An entrepreneur is any person or group starting a new business or organization. When starting a new business or organization, an entrepreneur seeking capital financing often sets a minimum amount required (MAR) per investor. That is, each investor is required to contribute at least the MAR amount if they desire to be an investor in the new business venture. The present invention forms a pool of investors, each of whom have contributed less money than the minimum amount required, but whose total amount of money meets or exceeds that minimum amount required by the Entrepreneur. By using the present invention, individuals who do not otherwise have the necessary amount of money to invest in an interesting or possibly lucrative business can join an investor group through which they can invest in such a business. Also, the entrepreneur can more easily accept investment money from a larger pool of individuals, thus making it easier to raise money for their business.

In one embodiment, shown in FIG. 3, the invention is performed through the implementation of a client-server based system over a globally connected computer network, such as the Internet. A server 300 communicates with each individual client 310 via the Internet 305. The server 300 contains website information including web pages written in HTML, ASP, XML, Perl, JavaScript, and the like, as well as application programs and databases to perform the invention. Clients 310 interact with the website over the Internet to receive and transmit information between the client and the server. Clients can be any type of computer or smart device with the capability to connect to the Internet. These devices include, but are not limited to, desktop computers, laptop or notebook computers, cellar phones, smart phones, PCS phones, personal digital assistants (PDA's), two-way pagers, web enabled televisions, and the like.

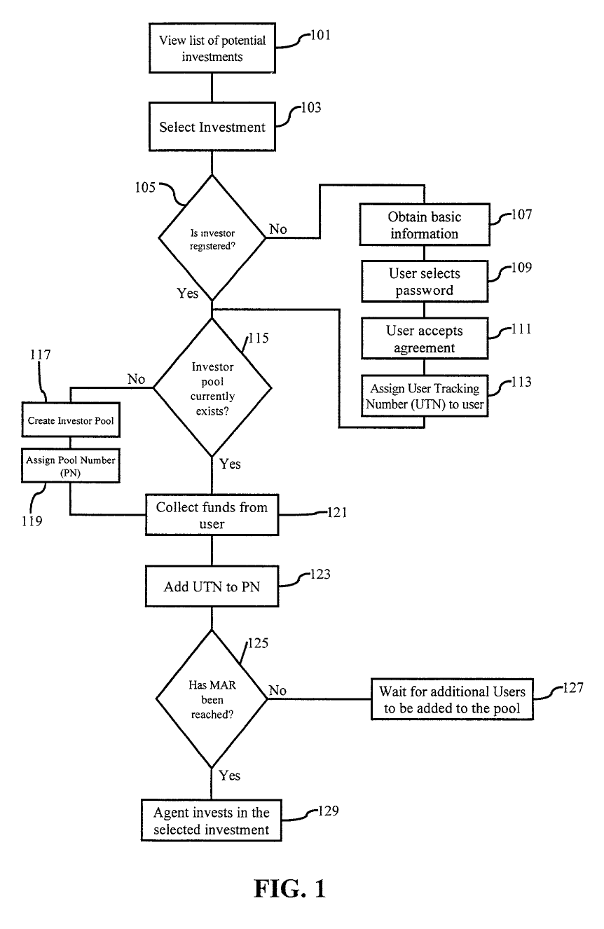

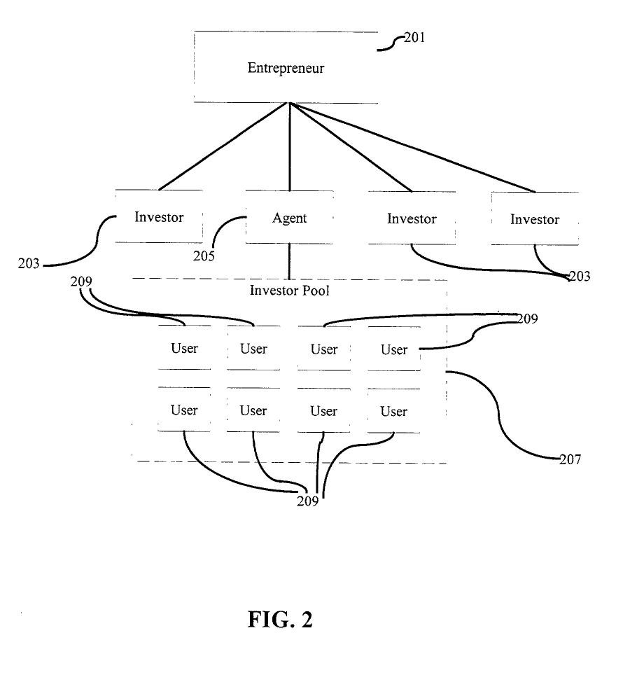

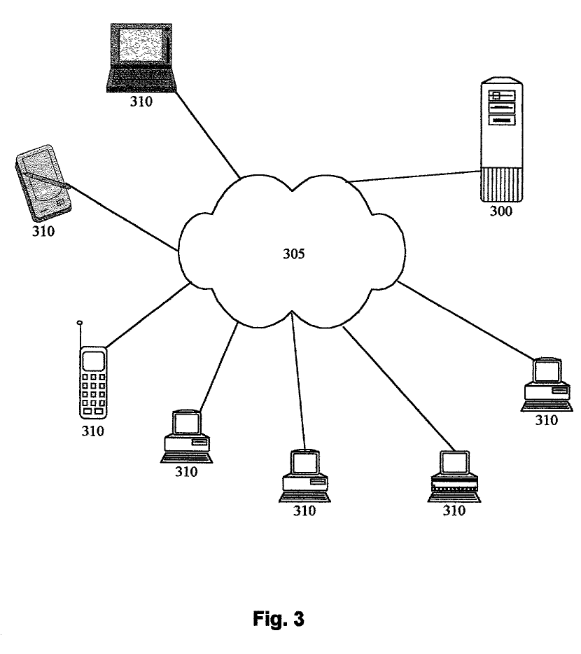

The process is described with respect to FIGS. 1-2. Entrepreneurs provide the organization performing the invention, hereinafter referred to as the Agent, with details regarding their investment opportunity, namely the business idea, capital sought, and other information helpful to an investor to make an investment decision. This may be performed via regular United States mail, or directly through the Internet website on the Agent's server 300. That is the entrepreneur visits the server, logs in for security, and enters the pertinent information through a form on a web page. The list of possible investments received from each entrepreneur is kept on the Agent's server. An investor views the list of potential investments in step 101, which may include new business ventures, movies awaiting financing, television shows needing production capital, researchers seeking funding, or any other business seeking financing. This list of potential investments may also be viewed on a web page on the website, received via email, or even via United States mail When the investor decides in which investment to invest, the investor selects the investment via a web page in step 103.

The server is adapted to determine whether the investor is an approved investor in step 105. The server bases this determination on the investor's login information. An approved investor could be an accredited investor as determined by the SEC, or he could be an investor who has registered with the organization performing the present invention, or could be approved according to other predetermined criteria. Hereinafter an approved investor will be referred to as a registered investor. If the investor is not approved, then the server will prompt the investor through the registration process in steps 107-113.

The registration process consists in obtaining basic information from the investor, such as name, address, social security number, telephone numbers, fax number, email address, and the like. The user must also select a password. In addition, during the registration process, the user must agree to a registration contract that appoints the organization performing this invention to be the user's appointed agent for purposes of the selected investment. The contract could also state the user agrees to accept all communication in electronic format, and also that the user agrees to perform and communicate all necessary decisions and communications via email and the Agent's website. Once the investor has completed the registration process, the server assigns a user tracking number (UTN) to the user and continues with the pooling steps.

In the pooling steps, the server determines if an investor pool currently exists for the selected investment in step 115. If not, the server creates an investor pool in step 117, and assigns a pool number (PN) in step 119. If a pool already exists, the server records the PN for that investment. The server then collects the funds from the registered investor in step 121, and adds the registered investor's UTN to the PN for that investment in step 123. After the server collects funds from the user, the user is said to be a member of that pool. The funds may be collected via credit card, check, wire transfer, or otherwise. If collected other than by credit card, the user is notified that their membership in the pool is conditional on successful receipt of funds from the user by the Agent.

After the user is added to the pool, the system determines whether the MAR has been reached in step 125. If, after the user is added to the pool, the pool has not reached the MAR for the selected investment, the user is notified, vie email or otherwise, that the pool is still awaiting enough funds to continue to the investing stage of the process in step 127. If, however, the pool has reached the MAR for the selected investment, the server notifies all users who are members of the pool that the minimum amount has been reached, and that the Agent will invest the funds on the members' behalves in the selected investment in step 129.

In another embodiment (not shown), it is possible that the system requires a user to register before being allowed to view the list of potential investments.

Because the Entrepreneur 201 regards the Agent 205 as a single investor, similar to other investors 203 who invest in the Entrepreneur, managerial and administrative tasks are simplified. The users 209 are members of the Investor Pool 207, on whose behalf the Agent acts in making the investment.

Investors may or may not have voting rights in the businesses in which they have invested. In the case where the investor has voting rights, the Agent 205 will notify the users 209 in the investment pool that there is a decision that needs to be made regarding the investment. The users, once notified, will use their UTN and password to access the Agent's website, and will read the necessary information regarding the decision to be made concerning the investment. The decision is made by use of radio-style check boxes, voting buttons, or the like. Once all investors in the pool have made their decision, or by a cut-off date, whichever occurs first, the Agent notifies the Entrepreneur 201 of the decision of the investment pool 207. Generally, a simple majority is required by the users 209 to decide how to vote. In other embodiments, more or less than a simple majority is required, or the Agent has authority to vote on behalf of the investor pool. It is also possible to end voting when the required number of users 209 have voted either for or against a decision, such that even if the remainder of the users voted, the decision could not change.

If the Entrepreneur pays investors a return on their investments, the Entrepreneur only has to pay the Agent for the investor pool, instead of paying each user individually. The Agent then handles the administrative tasks pertaining to paying the individual investors in the investment pool, including notifying investors, paying investors, and record keeping, as well as any other necessary tasks involved. Typically, each user received a pro rata return on their investment, based on the amount of the initial investment.

It should be appreciated by those skilled in the art that modifications may be made, or various methods or systems may be used which are within scope and spirit of the present invention.

1. A method of raising money comprising the steps:
a) receiving an amount of money from a user, wherein said amount of money is less than a predetermined amount of money required from an entrepreneur for investment in the entrepreneur's business,
b) including the user in an investment group;
c) repeating steps a) and b) until the minimum amount of money required by the entrepreneur has been collected from a plurality of users; and
d) investing the money received in the entrepreneur's business:

2. The method of claim 1 further comprising the steps:
e) posting a list of potential investments; and
f) waiting for the user to select a potential investment.

3. The method of claim 2, further comprising the step:
g) determining whether an investment group for said potential investment exists, wherein if no investment group exists or if all existing investment groups for said investment are full, creating a new investment group.

4. A computer readable medium adapted with computer instructions comprising the steps of:
a) receiving an amount of money from a user, wherein said amount of money is less than a predetermined minimum amount of money required from an entrepreneur for investment in the entrepreneur's business;
b) including the user in an investment group; and
c) repeating steps a) through e) until the minimum amount of money required by the entrepreneur has been collected from a plurality of users.

5. The computer readable medium of claim 4, further adapted with computer instructions comprising the steps:
d) posting a list of potential investments; and
e) waiting for the user to select a potential investment.

6. The computer readable medium of claim 5, further adapted with computer instructions comprising the step:
f) determining whether an investment group for said potential investment exists wherein if no investment group exists or if all existing investment groups for said investment are full, creating a new investment group.

7. A computer system comprising:
a server adapted to perform the following steps:
a) receiving an amount of money from a user, wherein said amount of money is less than a predetermined minimum amount of money required from an entrepreneur for investment in the entrepreneur's business;
b) including the user in an investment group; and
c) repeating steps a) and b) until the amount of money required by the entrepreneur has been collected from a plurality of users.

8. The computer system of claim 7 wherein the server is further adapted to perform the following steps:
d) posting a list of potential investments; and
e) waiting for a user to select a potential investment.

9. The computer system of claim 8 wherein the server is further adapted to perform the following step:
f) determining whether an investment group for said potential investment exists, wherein if no investment group exists or if all existing investment groups for said investment are full, creating a new investment group.
